(19) United States
(12) Patent Application Publication
(10) Pub. No.: US 2015/0351586 A1
(43) Pub. Date: Dec. 10, 2015

(54) Outdoor Barbecue Grill

(71) Applicant: Robert Howell Taylor, Asheville, NC (US)

(72) Inventor: Robert Howell Taylor, Asheville, NC (US)

(21) Appl. No.: 14/829,997

(22) Filed: Aug. 19, 2015

(51) Int. Cl. A47J 37/07

(52) U.S. Cl. CPC A47J 37/0786; A47J 37/07

(57) ABSTRACT

Disclosed is an outdoor barbecue grill that includes a cylindrical housing member having a cone-shaped hood hingedly attached thereto. The housing member includes a defined interior volume for holding fuel source therein, wherein the fuel source can be inserted via a drawer-like opening disposed on the housing member. The interior volume of the housing member further includes a grill grate that is biased toward an upper end thereof. The climate of the interior volume of the housing member is regulated via a draft control, whereby the draft control can restrict the airflow to and from the interior and exterior of the housing member. Additionally, the upper end of the hood includes a damper for preventing moisture and debris from entering the housing member. The housing member is supported on a plurality of adjustable legs, wherein each of the legs includes a caster wheel with a lock thereon.

### FIELD OF THE INVENTION

The present invention generally relates to a barbecue grill. More particularly, the present invention is directed to a barbecue grill having a cone shape for enhancing performance and increasing efficiency of the same.

### BACKGROUND OF THE INVENTION

Outdoor cooking is a popular form of entertainment, particularly in warm seasons and summer holidays. Due to the popularity of outdoor cooking, various cooking apparatus and appliance are known. These include various types of grills that have been patented and published in patent application publications. Grills that are disclosed in the prior art generally comprise a bowl and a grill grate or a cooking surface thereon. The bowl is generally configured to hold fuel source such as charcoal therein. If the grill is gas-fueled, the bowl is connected to a natural gas or propane gas tank.

Traditional grills also comprise a removably or hingedly attached hood, wherein the hood is substantially hemispherical or dome-shaped. In this way, the hood does not directly contact the food that is placed on top of the grill grate. The devices disclosed in the prior art have several known drawbacks, however. While these grills allow a user to cook food by applying heat directly from below, they are not configured to cook food in an optimal manner. More specifically, traditional grills require a user to constantly check on the food during the cooking process to make sure that the food is cooked to the user's liking. Otherwise, the food can burn or undercook, which can cause foodborne illness. In this regard, these devices are limited in that they do not cook food in an optimal manner. Therefore, there is a need in the prior art for an outdoor cooking appliance that can cook food evenly and consistently to prevent food from burning or undercooking.

### SUMMARY OF THE INVENTION

In view of the disadvantages inherent in the known types of devices for grilling devices now present in the prior art, the present invention provides an improved barbecue grill having a cone-shaped hood for circulating heat in a uniform manner.

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as to prelude to the more detailed description that is disclosed later.

In a preferred embodiment, the present invention comprises a grill comprising a housing member having a substantially cylindrical shape with an open upper end and a closed lower end. Additionally, the housing member comprises a defined interior volume for holding fuel source therein. The interior volume of the housing member is accessible via a side opening with a closure for inserting the fuel source. The climate of the interior volume of the housing member is regulated via one or more draft/temperature control. The housing member further comprises a grill grate that is biased toward the upper end thereof.

The lower end of the housing member comprises a plurality of adjustable legs, wherein each of the legs comprises a caster wheel with a lock thereon. The upper end of the housing comprises a cone-shaped hood hingedly attached thereto. The hood comprises a defined interior volume and protects the food placed on the grill grate. The upper end of the hood includes a damper that prevents rain or other elements from entering into the interior volume of the housing member. The hood further includes a thermometer for measuring the temperature of the interior volume of the housing.

The present invention overcomes limitations of the prior art by disclosing the cone-shaped hood, which circulates heat similarly to a convection oven. In this way, the heated air within the interior volume of the housing member and the hood can rotate around the food while it is being cooked. Preferably, the present barbecue grill is composed of stainless steel, materials with ceramic coating, or other types of suitable material that can withstand weather and outside elements to prolong the use thereof.

It is therefore an object of the present invention to provide a barbecue grill having a cone-shaped hood for evenly circulating heated air around food while it is being cooked.

It is another object of the present invention to provide a barbecue grill that comprises a side opening for inserting fuel source into the interior thereof.

It is still another object of the present invention to provide a barbecue grill that comprises one or more draft/temperature control for regulating the interior climate thereof.

It is still another object of the present invention to provide a barbecue grill that comprises a plurality of adjustable legs with a caster wheel thereon for increasing portability of the same.

It is still another object of the present invention to provide a barbecue grill that is composed of stainless steel.

A final object of the present invention to provide a barbecue grill that may be readily fabricated from materials that permit relative economy and commensurate with durability.

In the light of the foregoing, these and other objects are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 is a front view of the present invention.

FIG. 2 is a perspective view of another embodiment of the present invention.

FIG. 3 shows a perspective view of the present invention.

FIG. 4 shows a close up view of the damper of the present invention.

FIG. 5 shows a close up view of the draft control of the present invention.

FIG. 6 shows a close up view of the hinges of the present invention.

FIG. 7 shows a view of the interior of the present invention.

FIG. 8 shows another view of the interior of the present invention.

FIG. 9 shows a view of the opening for inserting fuel source in the present invention.

### DETAILED DESCRIPTION OF THE INVENTION

The present invention is directed towards a barbecue grill. For purposes of clarity, and not by way of limitation, illustrative views of the present barbecue grill are described with references made to the above-identified figures. Various modifications obvious to one skilled in the art are deemed to be within the spirit and scope of the present invention.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” or “at least one” unless specified otherwise or clear from context to be directed to a singular form.

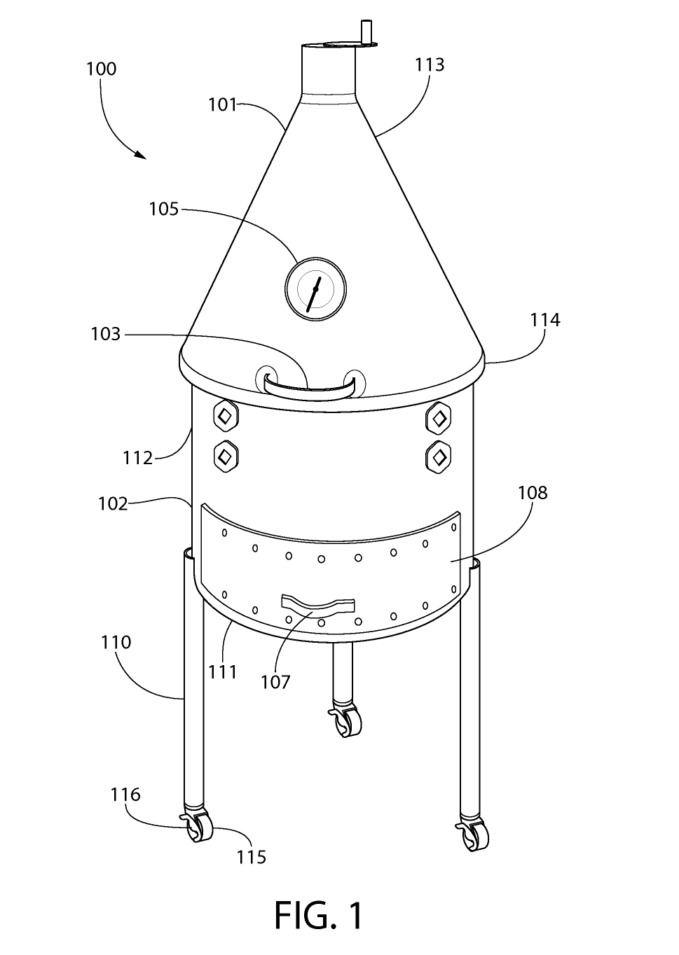

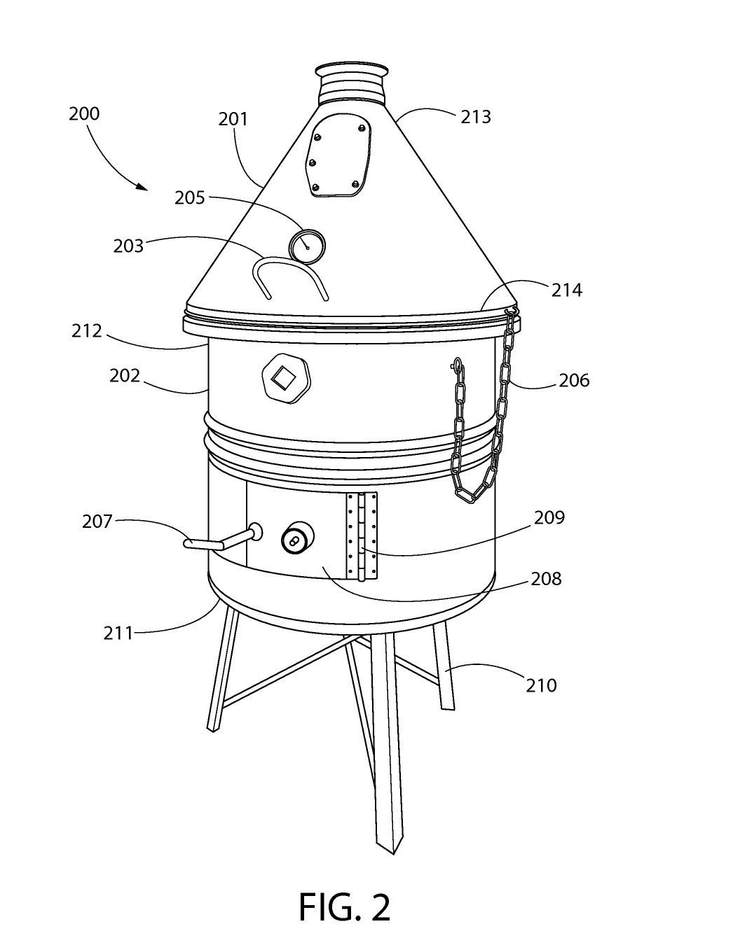

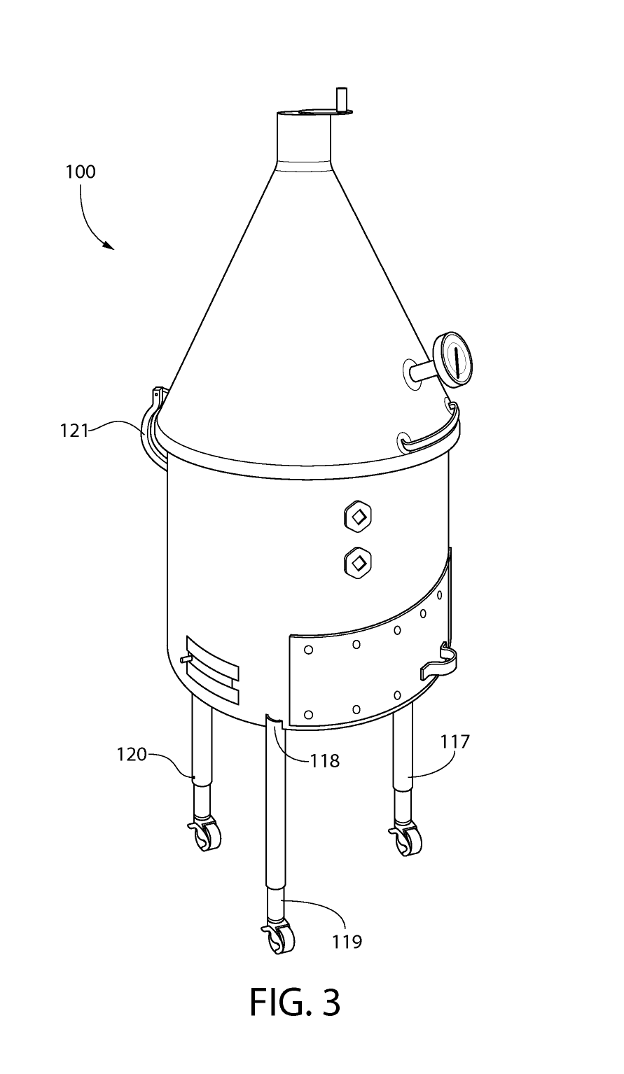

Referring now to FIGS. 1 through 3, there are shown views of exemplary embodiments of the present invention. The present invention comprises a barbecue grill 100, 200. The barbecue grill 100, 200 includes a housing member 102, 202 having a substantially cylindrical shape with a defined interior volume. The interior volume of the housing member 102, 202 is adapted to hold fuel source therein, as well as a grill grate for cooking food thereon. The fuel source can be inserted into the housing member 102 via a fuel source compartment 108, which can open and close via a handle 107. Alternatively, the fuel source can be inserted into the housing member 202 via an opening, which is accessible through a door 208 and a handle 207 attached thereto, wherein the door 208 is attached to the housing member 202 via hinges 209.

The housing member 102, 202 includes an open upper end 112, 212 and a closed lower end 111, 211. The diameter of the cross section of the housing member 102, 202 is uniform over its length, wherein the length of the housing member 102, 202 is defined as the distance between the upper end 112, 212 to the lower end 111, 211 thereof. In this regard, the housing member 102, 202 is not tapered.

The upper end 112 of the housing member 102 comprises a substantially cone-shaped or funnel-shaped hood 101 attached thereto via hinges 121. Alternatively, the hood 201 may be attached to the housing member 202 via a chain 206. The hood 101, 201 comprises an open lower end 114, 214 and an open upper end 113, 213. The distance between the lower end 114, 214 and the upper end 113, 213 of the hood 101, 201 defines the length thereof. The cross section of the hood 101, 201 is substantially circular in shape. The diameter of the cross section of the hood 101, 201 decreases from the lower end 114, 214 to the upper end 113, 213 thereof such that the hood 101, 201 resembles an inverted cone when viewed from the front, side, or the back.

The lower end 114, 214 of the hood 101, 201 directly contacts the upper end 112, 212 of the housing member 102, 202 when the grill 100, 200 is in a closed position. In this way, the diameter of the lower end 114, 214 of the hood 101, 201 is substantially equal to the diameter of the cross section of the upper end 112, 212 of the housing member 102, 202. In some embodiments, each of the upper end 112, 212 of the housing member 102, 202 and the lower end 114, 214 of the hood 101, 201 comprises a lip therearound so as to create a complete seal when the grill 100, 200 is in the closed position.

In operation, a user can open and close the hood 101, 201 via a handle 103, 203 attached thereto. In the closed position, the cone-shaped hood 101, 201 circulates heat similarly to a convection oven. In this way, the heated air within the interior volume of the housing member 102, 202 and the hood 101, 201 can rotate around the food while it is being cooked on top of the grill grate. It is contemplated that the entire grill 100, 200 is composed of stainless steel or other types of suitable, durable material that can withstand weather and outside elements to prolong the use thereof without rusting and/or corroding.

The hood 101, 201 further includes a thermometer 105, 205 for measuring the temperature of the interior volume of the housing member 102, 202. In this way, the user can determine whether the temperature of the interior volume of the housing member 102, 202 is the desired cooking temperature without opening the hood 101, 201 and utilizing another thermometer. It is contemplated that the thermometer 105, 205 comprises a cooking thermometer or a kitchen thermometer and that the thermometer can withstand excessive heat.

The lower end 111 of the housing member 102 comprises a plurality of legs 110 attached thereto, wherein each of the legs 110 comprises a caster wheel 115 with a lock 116 thereon. In this way, the grill 100 can be moved to different locations in a convenient manner and the user need not pick up the grill in order to transport it. In the illustrated embodiment, the housing member 102 is attached to three adjustable legs 110, wherein the legs 110 form a triangle configuration or a tripod configuration. In other embodiments, however, the present invention may comprise fewer or more than three adjustable legs.

It is contemplated that in some embodiments, the legs 117 may be adjustable in length, wherein the length of each of the legs 117 is defined as the distance between the upper end 118 of the leg 117 and the lower end 119 of the leg 117. The legs 117 may be telescopic in construction so that they can expand or retract. Additionally, each of the legs 117 may comprise a lock for securing the legs 117 at a desired length. In the illustrated embodiment, the lock comprises a fastener 120 for securing the legs 117 in place.

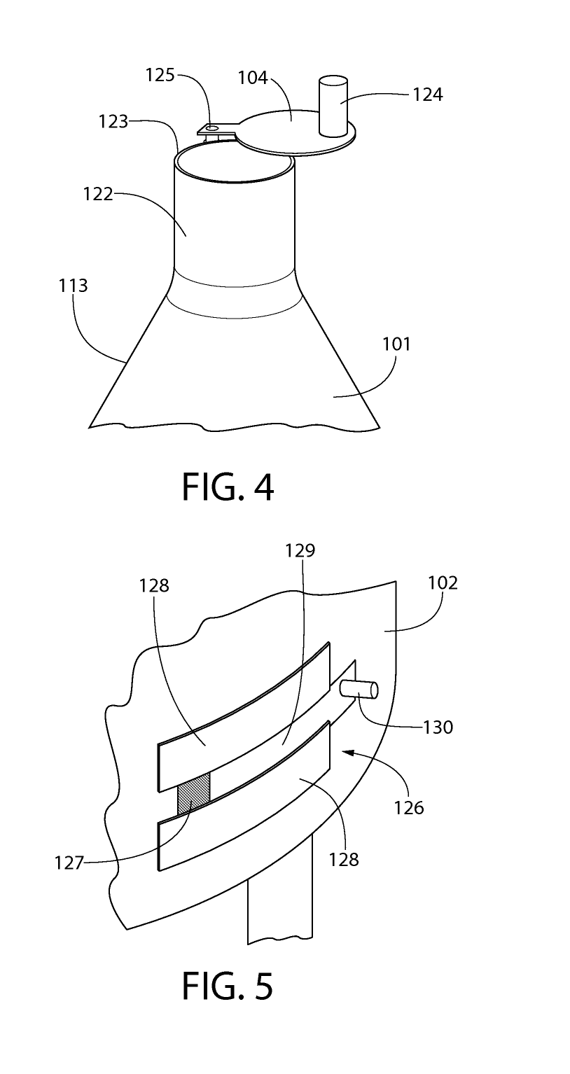

Referring now to FIG. 4 there is shown a close up view of the damper 104 of the present invention. The upper end 113 of the hood 101 includes a tubular portion 122 extending upward therefrom. The tubular portion 122 comprises a circular cross section having a diameter that is uniform over its length. Because the upper end 123 of the tubular portion 122 is open and does not come to a point, it is important to prevent moisture or debris from entering the interior volume of the housing member while providing air vent.

The upper end 123 of the tubular portion 122 includes a damper 104 attached thereto. The damper 104 comprises a circular plate that includes an upper surface that is coextensive with a lower surface. The upper surface includes a handle or a knob 124 extending upward therefrom. The damper 104 is attached to the upper end 123 of the tubular portion 122 via a fastener 125 so that it can slide into an open position and a closed position. The diameter of the plate of the damper 104 is substantially equal to or greater than the diameter of the cross section of the tubular portion 122 so that it that prevents rain or other elements from entering into the hood 101 and the interior volume of the housing member.

Referring now to FIG. 5, there is shown a close up view of the draft/temperature control 126 of the present invention. In the illustrated embodiment, the draft/temperature control 126 includes a rectangular opening 127 having a top edge and a bottom edge. Each of the top and bottom edges includes a plate 128 attached thereto, such that a portion of the plate is positioned over the opening 127 and another portion of the plate is positioned over the housing member 102. The plates 128 may be welded to the housing member 102 so that they are substantially unitary in structure. Each of the plates 128 creates a channel between the underside of the plate 128 and the opening 127. The plates 128 are parallel to each other and are spaced apart so as to create a gap and leave part of the opening 127 exposed.

Disposed between the plates 128 is a door 129 having a handle or a knob 130 extending outward therefrom. In the illustrated embodiment, the handle 130 is biased toward one end of the door 129. The door 129 is shaped and dimensioned to fit between the plates 128 and slide within the channels so that it can completely cover the opening 127 in a closed position and then slide sideways to an open position. The door 129 can also be slid to the side slightly so that it is opened only partially.

By controlling the size of the opening 127, the user can control the airflow to and from the exterior and interior of the grill. Controlling the airflow helps regulate the climate of the interior volume of the housing member 102. More specifically, increasing the size of the opening 127 helps decrease the temperature within the interior volume of the housing member 102 by allowing hot air to escape. Conversely, decreasing the size of the opening 127 helps increase the temperature within the interior volume of the housing member 102 by retaining hot air therein.

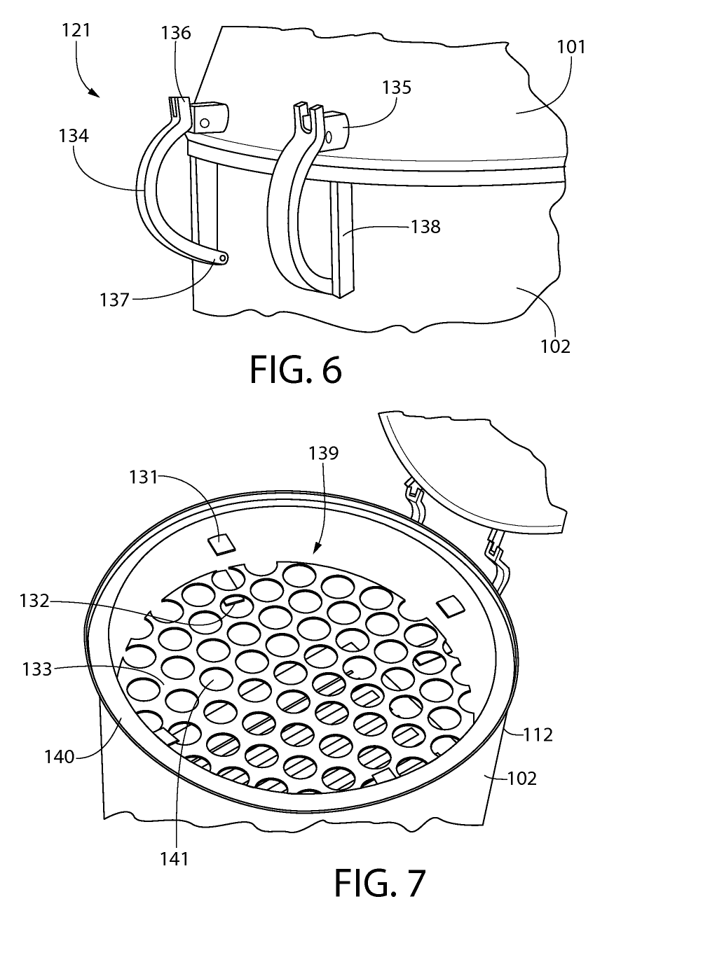

Referring now to FIG. 6, there is shown a close up view of the hinges 121 of the present invention. Preferably, the hinges 121 comprise a first section 134 attached to a second section 135. The first section 134 comprises a C-shape having an upper end 136 and a lower end 137, wherein the lower end 137 is attached to the housing member 102. The second section 135 is attached to the hood 102 and hingedly connects to the upper end 136 of the first section 134. In another embodiment, the first section 134 of the hinges 121 comprises a D-shape having a vertical portion 138 in addition to the C-shaped portion, wherein the vertical portion 138 is attached to the housing member 102 and the upper end 136 of the curved portion is attached to the second section 135.

Referring now to FIG. 7, there is shown a view of the interior of the present invention. The interior volume 139 of the housing member 102 comprises a grill grate 133 that is biased toward the upper end 112 thereof, wherein the upper end 112 comprises a lip 140 therearound. The grill grate 133 comprises a substantially circular shape with a plurality of openings 141 disposed thereon. In the illustrated embodiment, the openings 141 comprise a circular shape. In other embodiments, however, the openings may comprise various shapes and sizes.

The perimeter of the grill grate 133 rests on top of a plurality of pegs or support members disposed on the interior wall of the housing member. The pegs protrude perpendicularly inward and are spaced apart at regular intervals. The illustrated embodiment includes a first and second sets of pegs 131, 132 wherein the first set 131 is closer to the upper end 112 of the housing member 102 than the second set 132 so that the first set 131 is higher in elevation than the second set 132. Additionally, the pegs in the first set of pegs 131 are level with each other. Similarly, the pegs in the second set of pegs 132 are level with each other. In this way, the grill grate 133 remains level or substantially parallel to the ground, preventing food from sliding off of the grill grate 133.

The grill grate 133 can be placed on the first set of pegs 131 or the second set of pegs 132. When the grill grate 133 is placed on the first set of pegs 131, it is further away from the fuel source than when the grill grate 133 is placed on the second set of pegs 132. Thus, the cooking temperature is lower when the grill grate 133 is placed on the first set of pegs 131 than when it is on the second set of pegs 132.

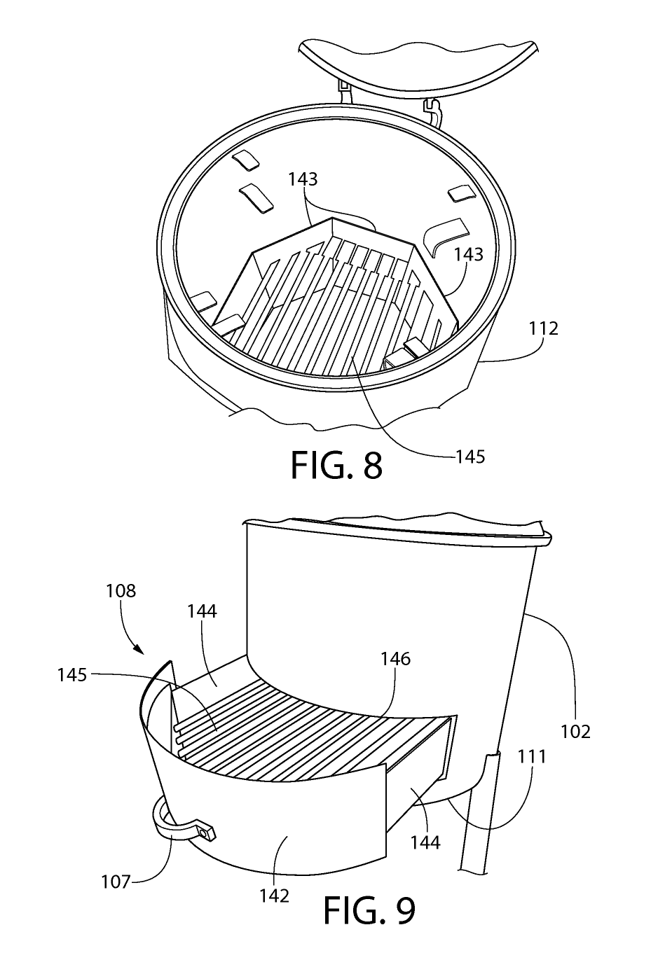

Referring now to FIGS. 8 and 9, there are shown views of the fuel source compartment 108 of the present invention. The fuel source compartment 108 is biased toward the lower end 111 of the housing member 102 and functions similarly to a drawer. In this regard the compartment 108 includes a bottom wall having a front wall 142, back walls 143, and side walls 144 extending upward therefrom, defining an interior volume therein and leaving the top open. The front wall 142 is curved to follow the contours of the housing member 102, and includes a handle 107 thereon.

The interior volume of the compartment 108 includes a plurality of rods 145 extending from the front wall 142 to the back walls 143. The rods 145 are spaced apart at regular intervals and are parallel with one another. The rods 145 are configured to support a fuel source thereon while allowing the ashes or other debris to fall therebetween.

The compartment 108 can extend outward from the housing member 102 and retract into the housing member 102 through an opening 146 disposed thereon. The front wall 142 of the compartment 108 is dimensioned so that it extends beyond the perimeter of the opening so as to completely cover the opening 146 when in a closed position. The accessibility of the compartment 108 from the exterior of the housing member 102 eliminates the need to remove the grill grate from the upper end 112 of the housing member 102 when adding fuel. Thus, the present invention increases convenience when adding fuel while cooking.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A barbecue grill, comprising:
a housing member having an open upper end, a closed lower end, and a defined interior volume for holding fuel source therein;
a grill grate within said interior volume, wherein said grill grate is biased toward said upper end of said housing member;
a fuel source compartment for inserting said fuel source in said interior volume, wherein said fuel source compartment can extend outward from and retract inward into said housing member through a first opening;
a cone-shaped hood hingedly attached to said upper end of said housing member;
a plurality of legs attached to said lower end of said housing member.

2. The barbecue grill of claim 1, wherein said housing member is substantially cylindrical in shape.

3. The barbecue grill of claim 1, wherein said plurality of legs is adjustable in length.

4. The barbecue grill of claim 1, wherein each of said plurality of legs comprises a caster wheel on a lower end thereof.

5. The barbecue grill of claim 4, wherein said caster wheel comprises a lock thereon.

6. The barbecue grill of claim 1, wherein said hood comprises a circular cross section with a diameter that decreases from a lower end to an upper end thereof.

7. The barbecue grill of claim 1, wherein an upper end of said hood is open, and said upper end of said hood comprises a damper for preventing outside elements from entering said interior volume of said housing member.

8. The barbecue grill of claim 1, further comprising a thermometer attached to said hood, wherein said thermometer is configured to measure a temperature of said interior volume of said housing member.

9. The barbecue grill of claim 1, said fuel source compartment having a bottom wall with a front wall, back walls, and side walls extending upward therefrom, leaving a top portion open; a plurality of rods extending between said front wall and said back walls.

10. The barbecue grill of claim 9, wherein said front wall is curved to follow the contours of said housing member.

11. The barbecue grill of claim 1, wherein said housing member further comprises one or more draft/temperature control for regulating climate of said interior volume of said housing member;
said one or more draft/temperature control comprising a second opening with a top edge and a bottom edge;
each of said top edge and said bottom edge having a plate attached thereto;
said plate forming a channel between said second opening and an underside of said plate;
a door configured to slide within said channel to an open position and a closed position.

12. The barbecue grill of claim 1, wherein each of a lower end of said hood and said lower end of said housing member comprises a lip therearound so as to create a complete seal when said lower end of said hood directly contacts said lower end of said housing member.

13. The barbecue grill of claim 1, further comprising a handle attached to said hood for facilitating opening and closing of said hood.
